(19) United States
(12) Patent Application Publication
(10) Pub. No.: US 2022/0397027 A1
(43) Pub. Date: Dec. 15, 2022

(54) WELLBORE PLANNING SYSTEMS AND METHODS

(71) Applicant: SCHLUMBERGER TECHNOLOGY CORPORATION, SUGAR LAND, TX (US)

(72) Inventors: Valerian Guillot, Montpellier (FR); Fatma Mahfoudh, Clamart (FR); Josselin Kherroubi, Clamart (FR); Anderson Schmidt, Rio de Janeiro (BR)

(21) Appl. No.: 17/661,943

(22) Filed: May 4, 2022

Related U.S. Application Data
(60) Provisional application No. 63/183,704, filed on May 4, 2021.

(51) Int. Cl. E21B 44/00; E21B 47/07; E21B 45/00

(52) U.S. Cl. CPC E21B 44/00; E21B 47/07; E21B 45/00; E21B 2200/20; E21B 2200/22

(57) ABSTRACT

Planning a wellbore includes determining drillability values from surface drilling parameters for an offset wellbore. The drillability values are used to prepare a protein code sequence of protein codes assigned to a range of drillability values. The protein code sequence from the offset wellbore is used to develop a protein code sequence for a planned wellbore. A machine learning model analyzes the offset surface drilling parameters and protein code sequence, and provides target surface drilling parameters for the planned wellbore.

### CROSS-REFERENCE TO RELATED APPLICATIONS

This application claims the benefit of, and priority to, U.S. Patent Application No. 63/183,704, filed May 4, 2021 and title “Wellbore Planning Systems and Methods”, which application is expressly incorporated herein by this reference in its entirety.

### BACKGROUND

Planning new wellbores in oil and gas exploration and drilling is complicated by the fact that the underground conditions, including formation characteristics, at the planned wellbore are not known with certainty. Underground conditions may be inferred from drilling information collected from offset wellbores. Wellbore planning systems often utilize drilling and formation information from offset wellbores to infer formation information at a planned wellbore.

### SUMMARY

In some embodiments, a method for planning a wellbore includes receiving an offset protein code sequence for an offset wellbore. The offset protein code sequence includes a plurality of protein codes. Each protein code corresponds to a range of drillability values that are representative of formation strength. A planned wellbore protein code sequence is planned for a planned wellbore based on the offset protein code sequence. An analysis of target surface drilling parameters for the planned wellbore is prepared based on the offset protein code sequence.

In some embodiments, a method for planning a wellbore includes receiving surface drilling parameters for the wellbore. Downhole drilling parameters are inferred based on the surface drilling parameters, and drillability values for the wellbore are determined based on the downhole drilling parameters. A plurality of protein codes is assigned to the drillability values, and a protein code sequence is prepared for the wellbore based on the plurality of protein codes.

In some embodiments, a method for planning a wellbore includes receiving a machine learning model that is trained to identify surface drilling parameters associated with drillability values and a rate of penetration. the machine learning model is provided with offset surface drilling parameters, drillability values, and rates of penetration. The machine learning model identifies target surface drilling parameters for a planned wellbore. The machine learning model is then refined based on observed surface drilling parameters.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a drilling system, according to at least one embodiment of the present disclosure;

FIG. 2 is a representation of a wellbore planning manager, according to at least one embodiment of the present disclosure;

FIG. 3-1 is a drillability chart, according to at least one embodiment of the present disclosure;

FIG. 3-2 is a protein code sequence of the drillability chart of FIG. 3-1;

FIG. 4. is a wellbore chart, according to at least one embodiment of the present disclosure;

FIG. 5 is a heat map of surface drilling parameters, according to at least one embodiment of the present disclosure;

FIG. 6-1 and FIG. 6-2 are schematic representations of a machine learning model, according to at least one embodiment of the present disclosure;

FIG. 7 is a flowchart of a method for planning a wellbore, according to at least one embodiment of the present disclosure; and

FIG. 8 is a flowchart of a method for planning a wellbore, according to at least one embodiment of the present disclosure.

### DETAILED DESCRIPTION

This disclosure generally relates to devices, systems, and methods for wellbore planning. Using surface drilling parameters, including measured weight-on-bit (“WOB”), rotations per minute (“RPM”), and mud flow rate, downhole drilling parameters may be inferred, including downhole WOB, RPM, and mud flow rate. A formation drillability value, such as a formation strength proxy, may be generated using the inferred downhole drilling parameters. The drillability values may be separated into multiple ranges, with each range being assigned a protein code. When planning a planned wellbore, a depth-based protein code sequence for the planned wellbore may be generated based on offset wellbore drillability values. The protein code sequence may include a series of protein codes, each of which corresponds to a range of drillability values. Using the protein code sequence, surface drilling parameters may be provided to optimize the rate of penetration for the planned wellbore.

In accordance with embodiments of the present disclosure, protein codes for a wellbore may be identified using one or more protein code assigner. The protein code assigner may analyze the drillability values for a wellbore based on time and/or wellbore depth. The protein code assigner may then assign a protein code to a region of the wellbore. To reduce variability in the protein codes, a filter or other process may be applied to the drillability values to identify and account for mutations, or outliers in the drillability values. The protein code assigner may identify changepoints in the drillability values. The changepoints may be used to identify where the wellbore changes between protein code regions. A wellbore sequencer may then prepare a code sequence for a specific wellbore. The code sequence may include an arrangement of protein codes along the depth of the wellbore. A code sequence for a specific wellbore may provide a useful summary for how the drillability of the wellbore changes over the depth of the wellbore.

In accordance with embodiments of the present disclosure, for a planned wellbore, a machine learning (“ML”) model may analyze the code sequences for offset wellbores near the planned wellbore and prepare recommendations of surface drilling parameters for each protein code. The ML model may be trained to identify correlations between the protein codes (which represent drillability values of the wellbore), surface drilling parameters, and the rate of penetration (“ROP”). The ML model may then prepare one or more analyses of the drilling parameters and how they affect the ROP. In some embodiments, the ML model may provide one or more heat maps that indicate how a single drilling parameter may affect the ROP. Using the analysis provided by the ML model, an operator may select the surface drilling parameters that will result in the highest ROP for the planned wellbore.

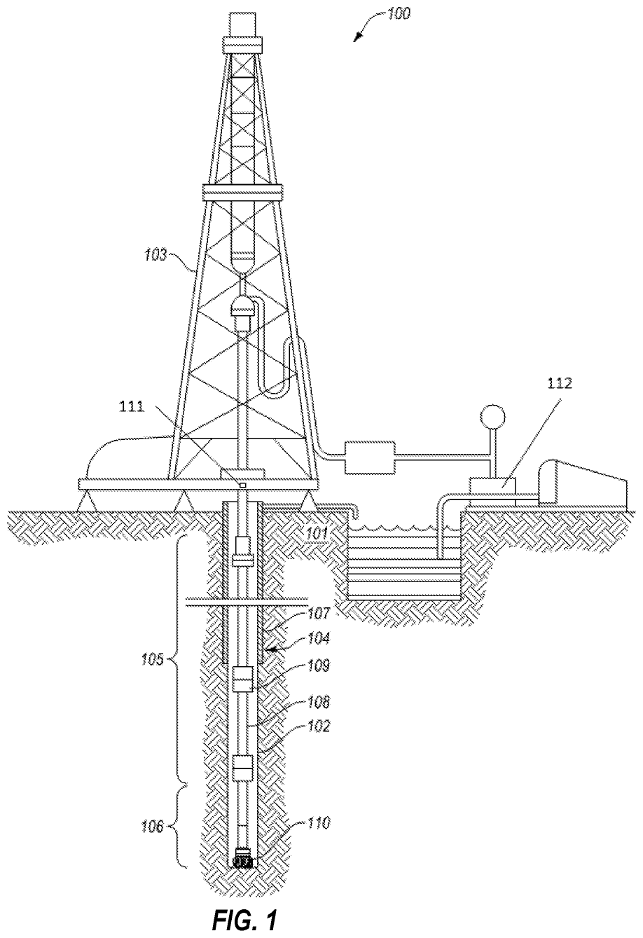

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid (e.g., drilling mud, mud) through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (“RSS”). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

During drilling operations, the bit 110 is rotated, which causes cutting elements on the bit 110 to engage the formation 101. The cutting elements may erode the formation 101, thereby advancing the wellbore 102. Many wellbores include one or more changes in direction, and indeed, a wellbore may include one or more lateral or horizontal sections. In accordance with embodiments of the present disclosure, wellbore depth may refer to the distance traveled along the wellbore, regardless of which direction the wellbore is traveling. A wellbore that travels 100 m into the formation and then doglegs and travels 100 m laterally would therefore have a wellbore depth of 200 m. Furthermore, formation depth may refer to the depth below the surface or other reference point (such as sea level).

The rate at which the bit 110 advances the wellbore 102 is the ROP. A higher ROP is generally desirable, because it may result in reduced costs of the total wellbore and/or earlier wellbore production. The ROP may be a result of many factors. One factor influencing the ROP may be the formation type of the formation 101. The formation type may include the lithography of the formation, such as rock type, hardness, abrasiveness, and so forth. The effect of the formation type on the ROP may be the drillability of the formation 101. As discussed herein, the drillability may be inferred from surface drilling parameters. A higher drillability value may generally correlate with a higher formation strength. A lower drillability value may generally correlate with a lower formation strength. For similar drilling parameters, a higher drillability of a formation may result in a lower ROP, and a lower drillability may result in a higher ROP.

A drilling operator may control several drilling parameters from the surface. For example, a drilling operator may control WOB, RPM, and mud flow rate. The WOB may be the force that the bit 110 applies to the formation 101 at the bottom of the wellbore. When drilling vertically, the WOB may be visualized as the weight of the drill string 105 and other drilling equipment that pushes on the bit 110. While drilling horizontally, the WOB may be visualized as the change in pressure, or Delta-P, applied on the bit. For ease of illustration, embodiments of the present disclosure may be described herein with respect to a vertical wellbore and the WOB. However, it should be understood that embodiments of the present disclosure are applicable to horizontal wellbore sections and Delta-P. In some situations, the WOB may be controlled by the amount of weight supported by the drill rig 103 through the Kelly, hook, turn table, and other elements of the drill rig 103. The WOB may be measured by a sensor 111 on the drill rig 103. The drilling operator may change the WOB may changing the weight supported by the drill rig 103, such as by reducing the rate at which the drill string 105 is lowered by the hook.

The RPM may be the rotational rate of the drill string 105 as measured at the drill rig 103 in rotations per minute. The RPM may be controlled by changing the rotations of the rotary table or other rotary element on the drill rig. The mud flow rate may represent the amount of drilling fluid that flows through the drill string 105, measured in fluid flow units such as gallons per minute (“GPM”), liters per minute (“LPM”), or other flow rate unit of measurement. The drilling fluid is passed through the drill string 105 using one or more pumps 112.

The operator has some control over the behavior of the bit 110 by changing one or more of these surface parameters. The operator may change the surface parameters to optimize the ROP based on changing drillability of the formation 101. In accordance with embodiments of the present disclosure, a wellbore planning system may provide the operator with a protein sequence representative of the drillability of the formation 101. The wellbore planning system may further provide an analysis of how each surface drilling parameter may affect the ROP. This may allow the operator to optimize the ROP for each portion of the wellbore 102.

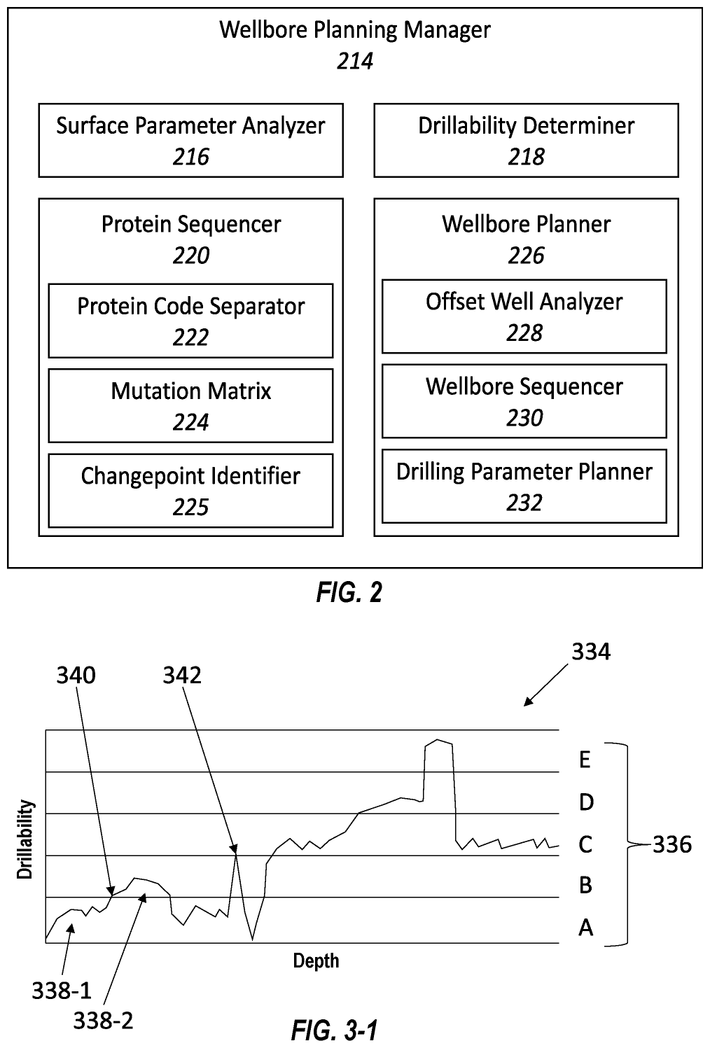

FIG. 2 is a representation of a wellbore planning manager 214, according to at least one embodiment of the present disclosure. The wellbore planning manager 214 may plan a particular wellbore based on drilling data received from offset wellbores, or wellbores that are located in a physically distant location from the planned wellbore. The wellbore planning manager 214 may analyze the drilling data from the offset wellbore and prepare a protein sequence from the drilling data. The wellbore planning manager 214 may then provide an analysis of the surface drilling parameters associated with each protein sequence to allow the operator to optimize the ROP for the planned wellbore.

The wellbore planning manager 214 may include a surface parameter analyzer 216. The surface parameter analyzer 216 may receive drilling data associated with a wellbore, such as an offset wellbore. The drilling data may include surface drilling parameters, such as WOB, RPM, and mud flow rate. The surface drilling parameters may be collected from sensors and other elements at the surface. For example, the WOB may be measured at a weight sensor on the drill rig (e.g., the sensor 111 of FIG. 1). The RPM may be measured at the drill rig (e.g., the drill rig 103 of FIG. 1). The fluid flow rate may be measured at one or more surface pumps (e.g., surface pumps 112 of FIG. 1). Drilling parameters may vary between the drill rig at the surface and downhole at the bit (e.g., the bit 110 of FIG. 1). For example, friction between the drill string and the wellbore wall may reduce the WOB felt at the bit from what is measured at the surface. Furthermore, friction with the wellbore wall and/or elastic deformation of the drill string may change the RPM measured at the surface with the RPM at the bit.

The surface parameter analyzer 216 may determine a torque loss between the drill rig at the surface and the bit downhole. Determining torque loss may include tracking a torque load on the hook. The torque load may be filtered according to a threshold torque value. The filtered torque load may then be statistically analyzed to determine a torque loss value between the surface and the bit downhole. This torque loss may then be used to infer the downhole WOB and the downhole RPM.

The wellbore planning manager 214 further includes a drillability determiner 218. The drillability determiner 218 may provide a proxy value for one or more formation properties of the formation through which a bit is drilling. For example, the drillability determiner 218 may provide a proxy value for formation strength. However, it should be understood that the drillability determiner 218 may provide a proxy value for any other geological and/or geomechanical property of the formation, including toughness, porosity, fracture properties, lithology, crystallography, any other property, and combinations thereof. The proxy value provided by the drillability determiner 218 may be call the drillability of the formation.

In accordance with embodiments of the present disclosure, the drillability determiner 218 may utilize downhole WOB, RPM, and bit size to determine the cutting force applied to the formation. In combination with the ROP, the cutting force may be used to determine the proxy for rock strength, or the drillability. In some embodiments, the drillability determiner 218 may determine the drillability using the downhole WOB and downhole RPM inferred by the surface parameter analyzer 216 from the surface drilling parameters. Thus, the drillability of the formation may be determined using the surface drilling parameters, and the surface drilling parameters may be associated with the drillability values. In some embodiments, the formation drillability may be determined by the drillability determiner 218 using direct measurements of the downhole WOB and RPM. In some embodiments, the drillability determiner 218 may determine the drillability of the formation using any other information, including survey information, information collected from core samples, exploration information, and so forth.

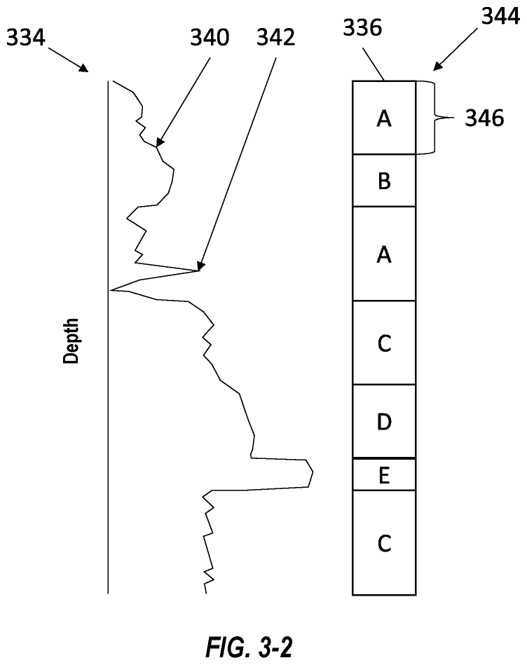

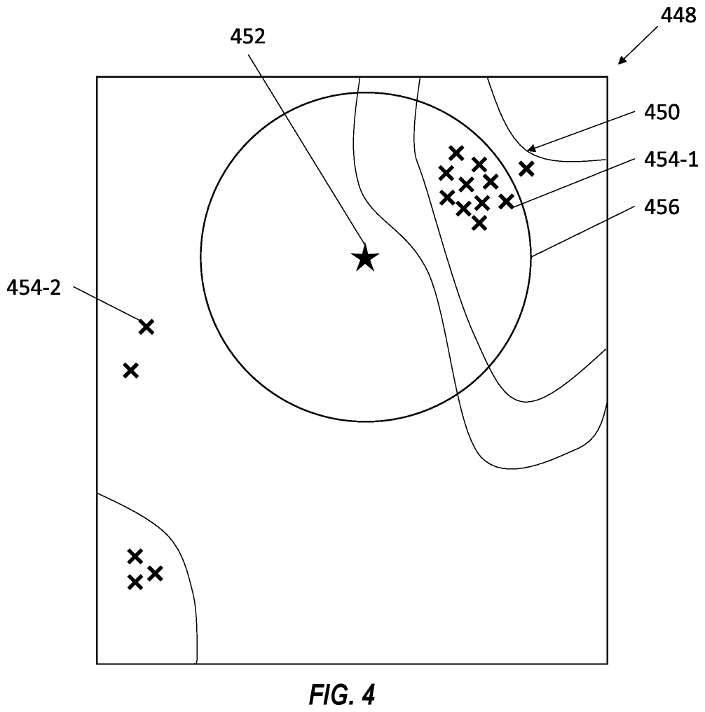

The drillability determiner 218 may receive downhole WOB and RPM measurements that are associated with wellbore depth. Using the wellbore depth, the drillability determiner 218 may assign a drillability value for each wellbore depth for which a depth measurement is provided. In this manner, a depth-based drillability chart for the wellbore may be developed using the determined drillability parameters, as may be seen in FIG. 3 (composed of FIGS. 3-1 and 3-2).

The wellbore planning manager 214 includes a protein sequencer 220. The protein sequencer 220 may analyze the drillability chart for the wellbore and assign a protein code to a region of the drillability chart. To assign the protein codes, the protein sequencer may split the drillability values into two or more drillability regions. The drillability regions may include a range of drillability values. In some embodiments, the protein sequencer 220 may split the total range of drillability values into equal ranges. For example, a first range may include drillability values from 1 to 10, a second range may include drillability values from 11 to 20, and so forth. Each range may be assigned a protein code. In this manner, when an operator sees that he or she is drilling through a formation assigned a particular protein code, the operator may know the approximate drillability of the formation based on the range of drillability values assigned to the protein code.

In some embodiments, the protein sequencer 220 may split the total range of drillability values based on known formation types. Different formation types may respond to different drilling parameters, and different formation types may cover different ranges of drillability values. By assigning a range of drillability values associated with a particular formation to a protein code, an operator may have a quick reference for which drilling parameters to use based on the identified protein code.

In some embodiments, the protein sequencer 220 may separate the drillability chart into different protein codes using a protein code separator 222. Geological formations typically maintain properties for an extended period. For example, a geological formation may be many tens of meters, and up to kilometers, thick. The properties of the formation may remain relatively constant for many tens of meters. Variations in the formation properties may be considered low-frequency variations, with the frequency being on the order of meters, tens of meters, hundreds of meters, or greater.

The drillability chart generated by the drillability determiner 218 may be noisy, and include many high-frequency peaks and valleys of drillability values. Due to the noise in the drillability chart, the drillability values may briefly move outside of the drillability range for a protein code having a particular drillability range when the formation actually has the drillability value. To reduce noise, the protein code separator 222 may apply a low-pass filter to the drillability chart. Because geological formations have low-frequency variability in drillability, a low-pass filter may help to reduce the noise in the drillability values.

To separate the drillability chart into a sequence of protein codes, the protein code separator 222 may identify one or more consensus sequences of drillability values. A consensus sequence may be a range of drillability values that the protein code separator 222 identifies as being within the identified range of drillability values for that protein code. The protein code separator 222 may identify the consensus sequence by identifying patterns within the range of drillability patterns. The patterns may be separated into common elements or protein codes.

In some embodiments, the protein code separator 222 may identify one or more consensus sequences by identifying and/or removing noise and/or irrelevant values using a mutation matrix 224. A mutation matrix 224 may help to identify outliers in the data. For example, the mutation matrix 224 may include a probability that a drillability value or series of values that lies outside of the range of drillability values that is representative of the characteristics of the formation. This may help the protein code separator 222 to determine whether a drillability value at a particular depth is part of the consensus sequence, a mutation, or a changepoint. In some embodiments, a mutation may be an outlier value that is inconsistent with the surrounding drillability values. Mutations may occur for any reason, including variation in equipment operation, variation in sensor measurements, variation in material handling, variation in any other element of the drilling system, and combinations thereof.

Using the mutation matrix 224, the protein code separator 222 may assign a mutation probability to a drillability value or series of drillability values. If the assigned mutation probability is above a mutation threshold, then the protein code separator 222 may determine that the outlier value is not representative of the actual drillability of the formation. For example, the protein sequencer 220 may identify a rate of change in the drillability values of the formation. The mutation matrix 224 may include a database of drillability rates of change, with an associated mutation probability. The protein code separator 222 may compare the rate of change of the drillability values at any time/depth to the database stored in the mutation matrix 224 and assign a mutation probability to the drillability value. If the mutation probability is above a mutation threshold, then the protein code separator 222 may determine that the drillability values are mutations, and drop/modify the drillability values accordingly. In this manner, the protein sequencer 220 may be able to assign protein codes and generate a protein code sequence that is representative of the actual drillability of the formation. This may help an operator to optimize the surface drilling parameters, thereby improving the ROP and/or reducing wear and tear on drilling equipment.

In some embodiments, the mutation matrix 224 may identify the probability that a particular protein code from one offset wellbore may be replaced with a different protein code from a second offset wellbore located nearby. Consider, as an example, four wellbores having the following protein code sequences:
Wellbore A: AAAACCDDDDEEEEAABAA
Wellbore B: AAABCCDDDDEEEEAAAAA
Wellbore C: AAAACCDDDDEEEEAAAAA
Wellbore D: ABAACCDEDDEEEEAAAAA

In accordance with embodiments of the present disclosure, the mutation probability matrix may indicate that the protein code A may be more likely to mutate into protein code B, and vice versa, than C or D, protein code B may be more likely to mutate into protein code C, and vice versa, than D, protein code C may be more likely to mutate into protein code D, and vice versa, than A, protein code D may be more likely to mutate into protein code E, and vice versa, than A or B, and so forth. Based on the identified mutations in the example wellbores provided above, the consensus sequence for the four wellbores may be represented by Wellbore C (e.g., AAACCDDDDEEEEAAAAA). While planning the wellbore, this protein code sequence may be utilized as the planned wellbore protein code sequence. This may allow the wellbore planner to identify a planned wellbore protein code sequence that corresponds to the most likely expected succession of intervals with a given drillability. Furthermore, this may help to reduce the noise in a generated planned wellbore by high frequency lateral formations, or noise in the drillability estimate.

In some embodiments, the protein code separator 222 may identify a consensus sequence using a changepoint identifier 225. The changepoint identifier 225 may identify when the drillability changes between protein codes. As discussed herein, the drillability chart may be noisy. Furthermore, in some situations, a change in rock properties may be gradual. In these situations, identifying the point at which the formation changes between protein codes may be difficult. In accordance with embodiments of the present disclosure, the changepoint identifier 225 may identify these changes between protein codes. In some embodiments, the changepoint identifier 225 may identify when the rolling average drillability (e.g., the average drillability per meter, per tens of meters). A change in the rolling average drillability may indicate that the formation has changed drillability, and that the change in drillability values is not simply noise. In this manner, the protein sequencer 220 may be able to assign protein codes and generate a protein code sequence that is representative of the actual drillability of the formation. This may help an operator to optimize the surface drilling parameters, thereby improving the ROP and/or reducing wear and tear on drilling equipment.

In some embodiments, the changepoint identifier 225 may be in communication with the mutation matrix 224. In some embodiments, changepoint identifier 225 may identify the rate of change of the change in drillability values, and use the rate of change to identify a change in protein code. For example, a change in formation types (e.g., lithography) may be sharp, occurring over a meter or less. The drillability of the first formation may be lower than the second formation. To identify the changepoint between the two formation types, the changepoint identifier 225 may determine that a high rate of change resulting from an increase in drillability may be associated with a low rate of change before and after the transition. The mutation matrix 224 may assign a high probability of a mutation to the high rate of change of drillability values. The changepoint identifier 225 may be able to recognize the pattern and determine that the high rate of change is associated with a change in protein code, and not a mutation. In some embodiments, any changepoint identification mechanism that can separate patterns from high frequency noise in a drillability chart may be used to identify changepoints in the drillability chart.

Using the identified changepoints, the protein code separator 222 may separate or split the drillability chart into multiple protein codes. The protein sequencer 220 may then assemble the protein codes into a protein code sequence. The protein code sequence may be an arrangement of protein codes in a particular order. The protein code sequence may be depth-based. For example, each protein code may be associated with a depth or a range of depths of the wellbore. In this manner, a drilling operator may be able to quickly visualize or otherwise identify the drillability of the wellbore across its depth. In some embodiments, the protein code sequence may include depth values for both the wellbore depth and the elevation of the wellbore. This may allow the protein code sequence for the wellbore to be compared to other wellbores, even if one or more of the wellbores includes one or more doglegs or non-vertical sections.

The wellbore planning manager 214 may further include a wellbore planner 226. The wellbore planner 226 may analyze the protein code sequences from one or more offset wellbores, prepare protein code sequence for a planned wellbore, and provide an analysis of drilling surface parameters for the planned wellbore. In this manner, the wellbore planner 226 may help a drilling operator to plan a wellbore, including planning the particular set of surface drilling parameters for the planned wellbore that may optimize the ROP of the planned wellbore. This may help to reduce costs by reducing the drilling time in a well, reduce wear and tear on the drilling equipment by optimizing drilling parameters, and increase the number of feed drilling in a shift or day.

The wellbore planner 226 may include an offset well analyzer 228. The offset well analyzer 228 may receive the protein code sequences generated by the protein sequencer 220 for wellbores that are offset from the planned wellbore. As discussed herein, an offset wellbore may be any wellbore that is not physically located in the same location as the planned wellbore. In some embodiments, an offset wellbore may include a wellbore that originates from a different surface location (e.g., from a different collar). In some embodiments, an offset wellbore may include a wellbore that originates from the same surface location, but follows a different path downhole. For example, many wellbores may include one or more lateral wellbores that branch off from a main wellbore. An offset wellbore may include the lateral wellbore that does not share an axis or other elements of the main or primary wellbore. In some embodiments, an offset wellbore may include any type of wellbore. For example, an offset wellbore may include production wellbores and/or exploration wellbores. In some embodiments, an offset wellbore may have the same diameter as the planned diameter for the planned wellbore. In some embodiments, an offset wellbore may have a larger or a smaller diameter than the planned diameter for the planned wellbore.

The offset well analyzer 228 may analyze the protein code sequence from the offset wellbores and interpolate the protein codes out to the planned wellbore. The wellbore planner 226 may further include a wellbore sequencer 230. The wellbore sequencer 230 may use the interpolated protein codes at the planned wellbore to prepare a protein code sequence for the planned wellbore. The wellbore sequencer 230 may prepare protein codes based on patterns identified by the offset well analyzer 228 between two or more offset wellbores. For example, the offset well analyzer 228 may identify that a particular protein code is reducing in thickness in offset wellbores that are closer to the planned wellbore. Based on this pattern, the wellbore sequencer 230 may determine an upper depth, a thickness, and a lower depth of the protein code. In some embodiments, the wellbore sequencer 230 may prepare a planned wellbore protein sequence code from the interpolations, patterns, and other analyses of the offset wellbore protein code sequences by the offset well analyzer 228 performed.

Using the offset well analyzer 228 and the wellbore sequencer 230, the protein code sequence prepared for the planned wellbore may be reflective of the actual conditions of the formation through which the planned wellbore may travel. In some embodiments, the offset well analyzer 228 may analyze wellbores within an analysis zone. The analysis zone may be an area that includes the planned wellbore. Any wellbores having a surface location within the analysis zone, or underground footprint that intersects the footprint of the analysis zone, may be analyzed by the offset well analyzer 228. In some embodiments, the analysis zone may be circular and centered on the planned wellbore. In some embodiments, the analysis zone may have any shape surface footprint. In some embodiments, the analysis zone may follow the known extent of one or more formations. A larger analysis zone may allow the offset well analyzer 228 to analyze more offset wellbores. Analyzing more offset wellbores may provide more data for the offset well analyzer 228 and/or the wellbore sequencer 230 to use to prepare the planned wellbore protein code sequence, thereby improving the accuracy of the planned wellbore protein code sequence.

The wellbore planner 226 further includes a drilling parameter planner 232. The drilling parameter planner 232 may provide an analysis of the surface drilling parameters that may be used for a particular protein code from the planned wellbore protein code sequence. In some embodiments, the drilling parameter planner 232 may analyze the surface drilling parameters compared to the ROP from the offset wellbores analyzed by the offset well analyzer 228. The drilling parameter planner 232 may determine how variations of the surface drilling parameters affected the ROP for a given protein code. The drilling parameter planner 232 may then prepare an analysis of varying the surface drilling parameters may affect the ROP. In some embodiments, the drilling parameter planner 232 may prepare a different analysis of the surface drilling parameters for each protein code of the planned wellbore protein code sequence. In some embodiments, the drilling parameter planner 232 may prepare an analysis of the surface drilling parameters for each unique protein code of the planned wellbore protein code sequence. In some embodiments, the drilling parameter planner 232 may prepare a heat map or other visual representation of the effect of the various effects of the surface drilling parameters. In some embodiments, the drilling parameter planner 232 may prepare an analysis of how the various drilling surface parameters may affect each other.

For example, the drilling parameter planner 232 may provide a heat map that indicates how the WOB impacts the ROP. In some examples, the drilling parameter planner 232 may provide a comparison of how the RPM impacts the ROP. In some examples, the drilling parameter planner 232 may provide a comparison of how the drilling fluid flow rate impacts the ROP. In some embodiments, the drilling parameter planner 232 may provide an analysis of how the WOB impacts the RPM and vice versa. In some embodiments, the drilling parameter planner 232 may provide an analysis of how the drilling fluid flow rate impacts the RPM and vice versa. In some embodiments, the drilling parameter planner 232 may provide an analysis of how the drilling fluid flow rate impacts the WOB and vice versa.

In some embodiments, the drilling parameter planner 232 may provide an analysis of how two different surface drilling parameters affects the ROP. For example, the drilling parameter planner 232 may provide a 3-dimensional graphic showing how changing the WOB and RPM (on the x and y axes) affects the ROP (on the z axis). In some embodiments, the drilling parameter planner 232 may provide a 3-dimensional graphic showing how changing the WOB and fluid flow rate affects the ROP. In some embodiments, the drilling parameter planner 232 may provide a 3-dimensional graphic showing how changing the RPM and fluid flow rate affects the ROP. Providing a visual representation (either 2-dimensional or 3-dimensional, as discussed herein) of how one or more surface drilling parameters may affect the ROP may help a drilling operator to optimize the surface drilling parameters to increase the ROP.

In some embodiments, the drilling parameter planner 232 may provide an analysis of how changing the WOB, RPM, and fluid flow rate may change the ROP. Because four dimensions are difficult to visualize graphically, the drilling parameter planner 232 may provide a formula, input dialog boxes, or other interface to provide an analysis of how changing the WOB, RPM, and fluid flow rate may change the ROP.

In some embodiments, the offset well analyzer 228 may include other drilling parameters, such as bit size, bit type (e.g., drag bit, rotary bit, hybrid bit), cutting element type, BHA components (e.g., stabilizers, casing cutters, reamers, power generation components, survey components, communication components), drilling fluid type (e.g., oil-based, water-based), drilling fluid density, any other drilling parameter, and combinations thereof. In some embodiments, the drilling parameter planner 232 may incorporate all the drilling parameters into the planned wellbore parameter analysis. For example, the planned wellbore may have a different planned diameter than one or more of the offset wellbore. The drilling parameter planner 232 may be able to determine how changing the bit diameter may affect the ROP. This may allow the operator to plan wellbores that include one or more drilling parameters that are different from the offset wellbore parameters.

In some embodiments, the drilling parameter planner 232 may analyze the downtime of the offset wellbores and prepare a downtime analysis of the planned wellbore. For example, the drilling parameter planner 232 may associate one or more surface drilling parameters with downtime, including downtime associated with broken equipment. For example, while a high WOB is often associated with a high ROP, in some situations, a high WOB may increase wear and tear on the bit or other downhole drilling components, which may cause the drilling operator to trip the BHA out of the wellbore for repairs. Thus, while the instantaneous or short-term ROP may be high, the overall ROP for a particular protein code sequence and/or the entire wellbore may be reduced. The provided analysis of the ROP may take into account the reduction in overall ROP based on repairs associated with one or more surface drilling parameters. For example, the drilling parameter planner 232 may reduce the recommended WOB to reduce the wear and tear on the downhole drilling components. In this manner, a drilling operator increase the overall ROP and/or reduce wear and tear on the downhole equipment.

In some embodiments, the drilling parameter planner 232 may analyze the wear and tear and/or operating costs on the downhole drilling components associated with the surface drilling parameters. In some situations, wear and tear may not result in the downhole drilling components being tripped out of the wellbore, but may result in increased operating costs, including repair, rebuilding, or other rehabilitation costs. The drilling parameter planner 232 may provide an analysis of one or more surface drilling parameters with the operating costs of the drilling equipment. In this manner, a drilling operator may optimize the surface drilling parameters to reduce operating costs.

In some embodiments, the drilling parameter planner 232 may provide a recommendation of the one or more surface drilling parameters to use when drilling through a formation having a particular protein code sequence. For example, an operator may indicate that the drilling parameter planner 232 should prioritize ROP, and the drilling parameter planner 232 may provide recommended surface drilling parameters that may maximize the ROP. In some examples, an operator may indicate that the drilling parameter planner 232 should prioritize reducing operating costs, and the drilling parameter planner 232 may provide recommended surface drilling parameters that may reduce the operating costs. In some examples, an operator may indicate that the drilling parameter planner 232 should balance ROP with operating costs, and the drilling parameter planner 232 may provide recommended surface drilling parameters that balance ROP with operating costs. In this manner, the operator may optimize the surface drilling parameters based on his or her preferences.

In some embodiments, the drilling parameter planner 232 may provide an analysis of the uncertainty of the planned wellbore protein code sequence produced by the wellbore sequencer 230. For example, based on the mutation probability identified for one or more of the protein codes identified by the protein sequencer 220 for the offset wellbores, the drilling parameter planner 232 may provide a sequence mutation probability for one or more of the protein codes for the planned wellbore protein code sequence. The sequence mutation probability may be a probability that one or more parameters represented in the protein codes of the planned wellbore protein code sequence may be different. For example, the sequence mutation probability may provide a probability that the upper depth and/or the lower depth is different than the value provided in a particular protein code. In some examples, the sequence mutation probability may provide a probability that the actual drillability of the formation is equal to, greater than, or less than the range of drillability values represented by the protein code. In this manner, a drilling operator may identify which areas of the planned wellbore to pay special attention to during drilling operations, so that he or she may make changes based on local conditions.

In some embodiments, the wellbore planner 226 may include a ML model, which may be used to identify the patterns in the offset wellbores and provide the analysis of the drilling parameters. The ML model may be trained to identify how the drilling parameters interact with the drillability values and/or protein codes and the ROP of an offset wellbore. When a location for a planned wellbore is selected, the ML model may analyze the drilling parameters, protein codes, and ROP. Using the information from the offset wellbores, the ML model may then prepare the analysis of the drilling parameters (as described above with respect to the drilling parameter planner 232). In some embodiments, the ML model may identify one or more target surface drilling parameters and a target ROP for the planned wellbore.

In some embodiments, the ML model may be refined by providing observed drilling parameters, including observed surface drilling parameters, and determined drillability values determined from the observed surface drilling parameters and measured rates of penetration from the planned wellbore after the planned wellbore is drilled. The ML model may compare the observed drilling parameters and observed ROP to the target surface drilling parameters and the target ROP. The ML model may then be refined to a refined ML model based on the differences between the target and observed data. The ML model may be continually refined as more planned wellbores are drilled and more observed data becomes available. In this manner, the ML model may provide the operator with more representative target drilling parameters and target ROP for a planned wellbore.

In some embodiments, the ML model may prepare the planned wellbore protein code sequence. For example, the ML model may compare the protein code sequences between the offset wellbores and identify patterns, such as certain protein codes increasing and/or decreasing in thickness closer to the planned wellbore. In some embodiments, the ML model may then prepare a protein code sequence for the planned wellbore. In some embodiments, the ML model may be refined by providing observed drillability values. In this manner, the ML model may provide the operator with more representative planned wellbore protein code sequences.

In some embodiments, the wellbore planner 226 may include multiple ML models. For example, the wellbore planning manager 214 may include a first ML model. The first ML model may be included in the protein sequencer 220. The first ML model may analyze drillability charts, identify mutations, identify changepoints, separate the drillability charts into one or more protein codes, and prepare one or more protein code sequences. In some embodiments, a second ML model may be included in the wellbore planner 226. The second ML model may analyze surface drilling parameters from offset wellbores, prepare a planned wellbore protein code sequence, and prepare an analysis of the surface drilling parameters for each protein code of the planned wellbore protein code sequence.

FIG. 3-1 is a representation of a drillability chart 334 of a wellbore, according to at least one embodiment of the present disclosure. In the embodiment shown, drillability values are represented on the vertical axis (e.g., y-axis) and wellbore depth on the horizontal axis (e.g., x-axis). In some embodiments, a protein sequencer (e.g., the protein sequencer 220 of FIG. 2) may analyze the drillability chart 334 and separate it into one or more protein codes 336. In some embodiments, the protein sequencer may separate drillability chart into different segments based on a range of drillability values for each protein code 336. A depth range may be assigned to each protein code based on in which segment the drillability values lie.

For example, as may be seen, a first portion 338-1 of the drillability chart 334 lies within segment bounded by the protein code A, a second portion 338-2 of the drillability chart 334 lies within the segment bounded by the protein code B, and so forth. As discussed herein, the protein sequencer may identify one or more changepoints 340, that indicate a change between protein codes. The protein sequencer may assign a protein code 336 to each portion of the drillability chart 334 based on the drillability values.

In the embodiment shown, the drillability values of the drillability chart 334 may be instantaneous drillability values. The protein sequencer may identify the changepoints 340 as the location where the instantaneous drillability value moves between drillability ranges. Put another way, the protein sequencer may identify the changepoints 340 as the location where the drillability value changes from one protein code 336 to a different protein code 336.

In some embodiments, the protein sequencer may identify the changepoints 340 as the location where the rolling average (e.g., the average value over a depth range, the average value over a time range) of the drillability values changes between protein codes 336. For example, a brief increase in drillability value from protein code A to protein code B followed by a return in the drillability value to protein code A may not be a mutation. However, the brief increase may not cause the rolling average drillability to change protein codes 336. In some embodiments, the rolling average drillability may change the location of the changepoint 340 as visualized on the instantaneous drillability chart. Put another way, the rolling average drillability may be used to identify a changepoint at a particular depth. When the changepoint depth is observed or plotted on the drillability chart 334, the instantaneous drillability value at the changepoint depth may not be located on a border between protein codes.

In some embodiments, the protein sequencer may identify one or more mutations 342. As discussed herein, mutations 342 may be identified as an outlier to the data in depths surrounding the depth of the mutation 342. In the embodiment shown, at the mutation 342, the drillability values sharply increase from within the protein code A to a peak value within protein code C, and then sharply decrease back to a value within protein code A. In some embodiments, the protein sequencer may identify the sharp change in drillability values, and determine that the mutation 342 is an outlier. The protein sequencer may then determine that there is no change in protein code 336 at the mutation 342.

In the embodiment shown, each of the protein codes 336 covers the same range of drillability values. However, it should be understood that the protein codes 336 may be assigned to different ranges of drillability values. Furthermore, each of the portions (collectively 338) of the drillability chart 334 cover a different range of depths. It should be understood, that the depth range of the portions 338 of the drillability chart 334 may be based on the specific geology of the wellbore.

FIG. 3-2 is a representation of a protein code sequence 344 of the drillability chart 334 of FIG. 3-1, according to at least one embodiment of the present disclosure. In the embodiment shown, the drillability chart 334 has been rotated 90° clockwise so that depth is located on the y-axis. The protein sequencer has generated the protein code sequence 344 from the identified protein codes shown in FIG. 3-1. As may be seen, each protein code 336 extends along a depth range 346 of the drillability chart. The breaks between individual protein codes 336 may be located at the changepoints 340 identified in FIG. 3-1.

As may be seen, the second instance of the protein code A extends to include the mutation 342. When assigning the depth ranges 346 to the protein codes 336 of the protein code sequence 344, the protein sequencer dropped or modified the drillability value of the mutation 342. In this manner, the protein code sequence 344 may be more fully representative of the actual drillability of the formation.

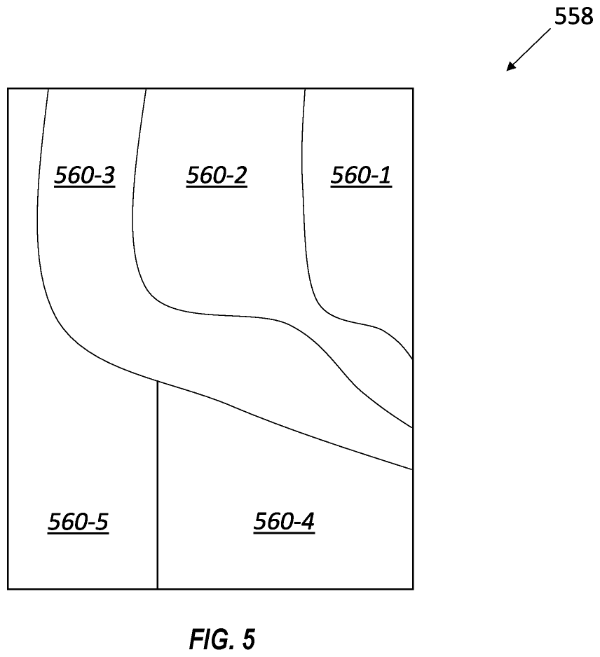

FIG. 4 is a representation of a wellbore chart 448, according to at least one embodiment of the present disclosure. The wellbore chart 448 may be a map or other location identifying element. The wellbore chart 448 shown includes one or more contour lines 450, which may be used to identify surface features of the wellbore chart 448. The wellbore chart 448 includes the location of a planned wellbore 452 and one or more offset wellbores (collectively 454). The planned wellbore 452 may be the target location of a planned wellbore. The offset wellbores 454 have a surface location that is offset from the planned wellbore 452.

In accordance with embodiments of the present disclosure, one or more, including all, of the offset wellbores 454 may include a protein code sequence for at least a portion of their depth. As discussed herein, a wellbore planner (e.g., the wellbore planner 226 of FIG. 2) may analyze the protein code sequences of the offset wellbores 454 to determine a protein code sequence for the planned wellbore 452. The wellbore planner may then use the surface drilling parameters from the offset wellbores 454 to prepare an analysis of target surface drilling parameters for the planned wellbore 452.

In some embodiments, the wellbore planner may analyze the offset wellbores 454 that are within an analysis zone 456 of the planned wellbore 452. In the embodiment shown, the analysis zone 456 is a circular area that is centered on the planned wellbore 452. However, it should be understood that the analysis zone 456 may be formed in any shape and may not be centered on the planned wellbore 452.

The wellbore planner may analyze any included offset wellbore 454-1 that is located inside of the analysis zone 456. Excluded wellbores 454-2 may be located outside of the analysis zone 456, and may not be included in the analysis of the wellbore planner. An operator may determine the analysis zone 456 based on any number of factors, including know formation extent, known differences in drilling equipment, property ownership, any other factor, and combinations thereof. In some embodiments, the analysis zone may include every wellbore in a database, such as every wellbore for which a company has drilling data.

The drilling operator may move the planned wellbore 452 based on the results of the analysis by the wellbore planner. For example, consider a formation having high drillability that is pinching out (e.g., reducing in thickness) toward the southwest (e.g., the lower right) of the wellbore chart 448. The operator may desire not to drill through this high drillability formation. Using the protein code sequences generated by the wellbore planner for the planned wellbore 452, the operator may move the planned wellbore 452 until the formation has disappeared in the planned wellbore protein code sequence or is below a thickness threshold. In this manner, the operator may plan the surface location of the planned wellbore based on the developed protein code sequence.

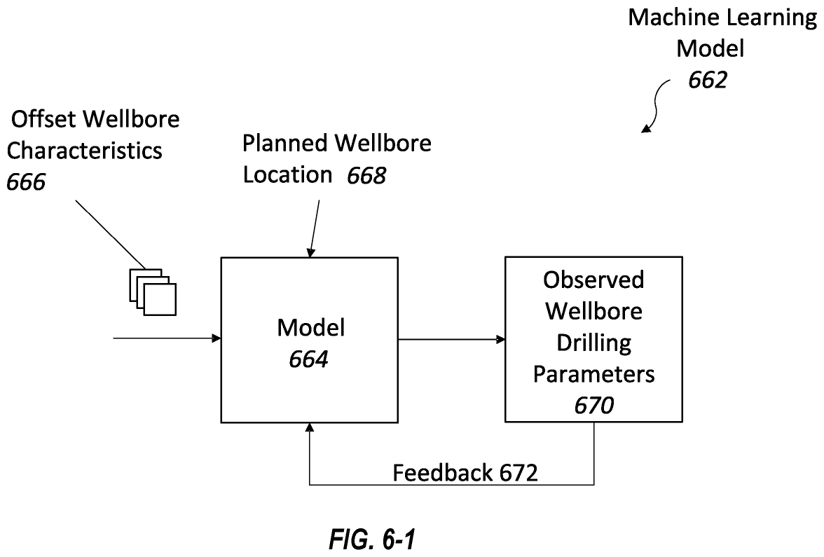

FIG. 5 is a representation of a heat map 558 of an analysis between a drilling parameter and ROP, according to at least one embodiment of the present disclosure. As discussed herein, a wellbore planner (e.g., the wellbore planner 226 of FIG. 2) may analyze the wellbore data from one or more offset wellbores relative to the planned wellbore. The wellbore planner may prepare an analysis of how the various drilling parameters may affect the ROP of the planned wellbore. In some embodiments, the wellbore planner may prepare the heat map 558 to provide the operator with a visual indication of how the drilling parameters may affect the ROP.

For example, consider the heat map 558 of FIG. 5 where WOB is represented on the horizontal axis (e.g., the x-axis) and RPM is represented on the vertical axis (e.g., the y-axis), with zones (collectively 560) of the heat map 558 being representative of the ROP. Each of the zones 560 may be associated with a ROP or a range of ROP. Each zone may be identified by a different color. In this manner, an operator may quickly and easily identify a combination of conditions that may maximize the ROP. In the embodiment shown, a first zone 560-1 may have a highest ROP, a second zone 560-2 may have a lower ROP than the first zone 560-1, a third zone 560-3 may have a lower ROP than the second zone 560-2, a fourth zone 560-4 may have a lower ROP than the third zone 560-3, and a fifth zone 560-5 may have a lower ROP than the fourth zone 560-4.

The first zone 560-1 may provide the highest ROP. As may be seen, the first zone 560-1 provides a range of WOB and RPM values, and the operator may achieve the ROP of the first zone 560-1 at any point within the first zone 560-1. In some embodiments, the wellbore planner may provide a recommended or an optimum WOB and RPM within the first zone 560-1.

While the heat map 558 has been described with respect to the WOB and RPM, it should be understood that the heat map 558 may be generated using any combination of drilling parameters. For example, the heat map 558 may be generated using WOB and drilling fluid flow rate, RPM and drilling fluid flow rate, or any other combination of drilling parameters. In some embodiments, the wellbore planner may generate multiple heat maps 558 that provide an analysis of drilling parameters with ROP. In some embodiments, the wellbore planner may generate one or more heat maps 558 for each protein code in a planned wellbore protein code sequence. In this manner, a drilling operator may have a drilling plan for each section of the wellbore to be drilled.

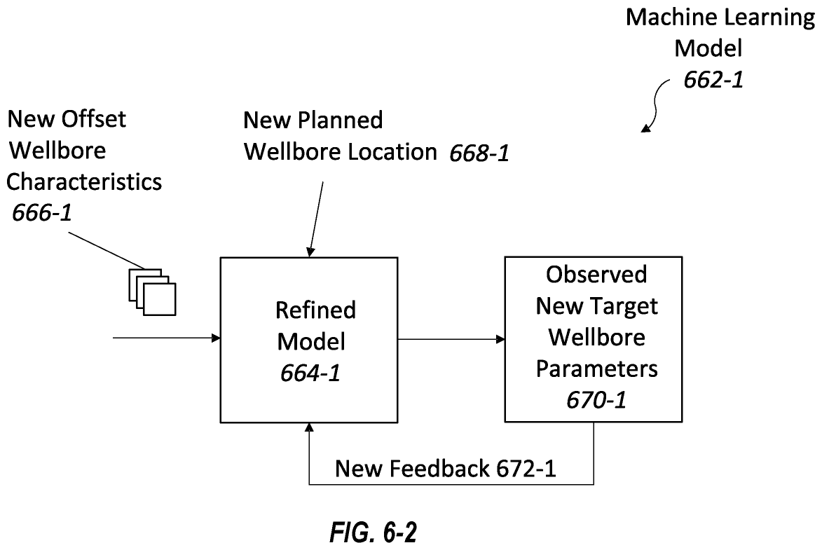

FIG. 6-1 is a representation of a ML model 662 for a wellbore planner, according to at least one embodiment of the present disclosure. The ML model 662 may include a model 664 trained to prepare planned wellbore protein code sequences and analyze surface drilling parameters for the protein codes of the protein code sequence. In some embodiments, the model 664 may receive offset wellbore characteristics 666, including offset surface drilling parameters, offset drillability values, offset rates of penetration, offset protein code sequences, offset mutation probabilities, any other characteristic of an offset wellbore, and combinations thereof, and the location of a planned wellbore 668.

Using the provided offset wellbore characteristics 666, the model 664 may prepare a target protein code sequence for the planned wellbore and provide an analysis of target surface drilling parameters for each target protein code of the target protein code sequence. For example, the model 664 may provide one or more target surface drilling parameters and an associated target ROP. In some embodiments, the model 664 may receive an input for the location of the planned wellbore. The model may identify the target protein code sequence and the corresponding target surface drilling parameters for the inputted location. In some embodiments, the model 664 may identify an analysis zone for the inputted location of the planned wellbore. The model 664 may identify the analysis zone based on analysis zone used in previous wellbores in the same region or area surrounding the inputted location.

When the planned wellbore is drilled, a drilling operator may collect observed wellbore drilling parameters 670 for the planned wellbore. The observed wellbore drilling parameters 670 may provide the model 664 with feedback 672. The feedback 672 may include the measured surface drilling parameters at each protein code of the planned wellbore. In some embodiments, the feedback 672 may include observed drillability values across the depth of the planned wellbore. In some embodiments, the feedback 672 may include observed protein codes across the depth of the planned wellbore. In some embodiments, the feedback 672 may include the ROP across the depth of the planned wellbore.

Using the feedback 672, the model 664 may be refined. For example, the model 664 may compare the observed planned wellbore protein code sequence with the predicted planned wellbore protein code sequence. In some embodiments, the model 664 may compare the observed surface drilling parameters and ROP with the target surface drilling parameters and ROP. As may be seen in FIG. 6-2, after receiving the feedback 672, the ML model 662 may become a refined ML model 662-1. The model 664 may become a refined model 664-1. The refined model may receive now offset wellbore characteristics 666-1 and a new planned wellbore location 668-1. The refined model 664-1 may analyze the new offset wellbore characteristics 666-1 and provide a new protein code sequence and a new analysis of the surface drilling parameters for the protein codes. The refined model 664-1 may continue to be refined with observed new target wellbore parameters 670-1 and new feedback 672-1.

While the ML model 662 and the refined ML model 662-1 of FIG. 6-1 and FIG. 6-2 are described as a single ML model, it should be understood that the ML model 662, 662-1 may include more than one ML models. For example, the model 664 may receive drillability charts as part of the offset wellbore characteristics 666. A first ML model in the model 664 may separate the drillability charts into protein codes and a protein code sequence from the drillability charts. A second ML model may then utilize the protein code sequences from first ML model to prepare the planned wellbore protein code sequence for the planned wellbore location 668.

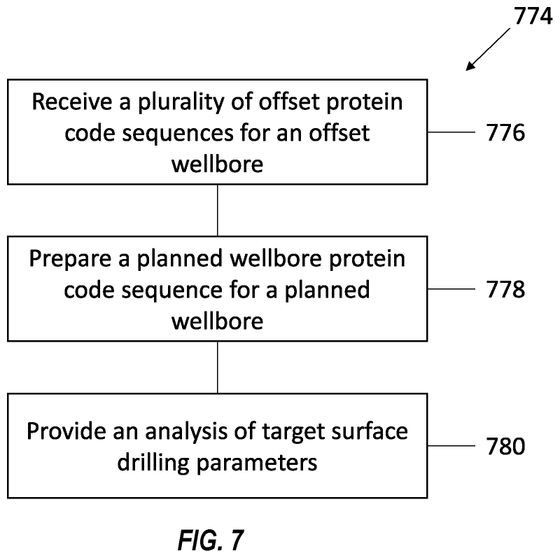

FIG. 7 is a flowchart of a method 774 for planning a wellbore, according to at least one embodiment of the present disclosure. The method 774 may be performed by the wellbore planning manager 214 of FIG. 2. Put another way, the wellbore planning manager 214 may perform the method 774 described with respect to FIG. 7.

In some embodiments, the wellbore planning manager may receive an offset protein code sequence for an offset wellbore at 776. The offset protein code sequence may include a plurality of protein codes. Each protein code may correspond to a range of drillability values, and the drillability values may be representative of the formation strength of the formation. The wellbore planning manager may prepare a planned wellbore protein code sequence for a planned wellbore at 778. The planned wellbore protein code sequence may be based on the offset protein code sequence of the offset wellbore. In some embodiments, the planned wellbore protein code sequence may be based off of a plurality of offset wellbore protein code sequences from a plurality of offset wellbores. In some embodiments, the plurality of offset wellbores may be located within an analysis zone of the planned wellbore.

The wellbore planning manager may provide an analysis of target surface drilling parameters for the planned wellbore based on the offset protein code sequence at 780. In some embodiments, providing the analysis of the target surface drilling parameters may include providing one or more heat maps of the target surface drilling parameters. In some embodiments, a plurality of heat maps may be provided for a single protein code of the planned wellbore protein code sequence. In some embodiments, providing the analysis of the target surface drilling parameters may include providing an analysis of the target surface drilling parameters for an individual protein code of the planned wellbore protein code sequence. In some embodiments, providing the analysis of the target surface drilling parameters may include providing an analysis of the target surface drilling parameters for each protein code of the planned wellbore protein code sequence.

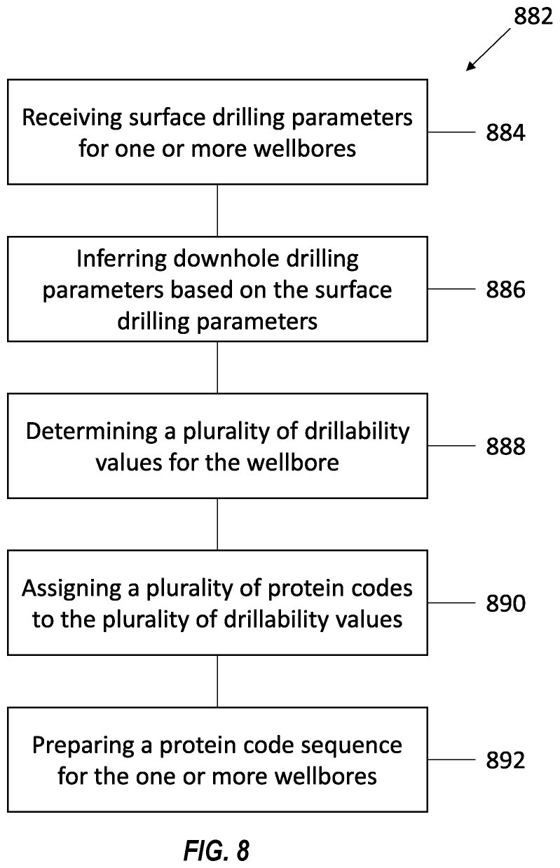

FIG. 8 is a flowchart of a method 882 for planning a wellbore, according to at least one embodiment of the present disclosure. The method 774 may be performed by the wellbore planning manager 214 of FIG. 2. Put another way, the wellbore planning manager 214 may perform the method 882 described with respect to FIG. 8.

The method 882 may include receiving surface drilling parameters for a wellbore at 884. In some embodiments, the wellbore may already be drilled. Put another way, the wellbore may be an existing wellbore. The received surface drilling parameters may include at least one of WOB, ROP, drilling fluid flow rate, or ROP. In some embodiments, the wellbore planning manager may infer downhole drilling parameters using the surface drilling parameters at 886. In some embodiments, the wellbore planning manager may determine a plurality of drillability values for the wellbore based on the surface drilling parameters at 888. In some embodiments, the drillability values may include a proxy for a formation strength of the formation through which the wellbore is drilled.

The wellbore planning manager may assign a plurality of protein codes to the plurality of drillability values at 890. Each protein code may correspond to a drillability range, or a range of drillability values. The protein codes may then be assembled into a protein code sequence for the wellbore at 892. Each protein code in the protein code sequence may have a depth range that corresponds to a depth of the drillability range. In some embodiments, to assign the protein codes, a low-pass filter may be applied to the drillability values.

In some embodiments, genomic sequencing mechanisms may be utilized to assign the plurality of protein codes. For example, the genomic sequencing mechanisms may be used to identify a consensus sequence of a range of drillability values. Identifying the consensus sequence may include identifying the probability of a mutation within the range of drillability values. The mutation may cover a single or multiple drillability values. If the probability of a mutation is high, e.g., above a mutation threshold, then identifying the consensus sequence may include omitting the mutation (or the drillability values associated with the mutation) from the range of drillability values.

In some embodiments, identifying the consensus sequence may include detecting changepoints in the drillability values. In some embodiments, assigning the protein codes may include separating the protein codes based on the detected changepoints. Put another way, the protein codes may be assigned based on the detected changepoints. Additionally, while the codes are described as protein codes that may be similar or identical to those used to describe DNA proteins, it will be understood that the disclosure is no limited to any particular set of codes or characters. Rather, the protein codes may be any suitable character, set of characters, identifier, or the like. For instance, suitable protein codes can include single letters, multiple letters, words, symbols, numbers, or the like, in any suitable spoken, written, programming, or contrived language, or any combination of the foregoing.

The embodiments of the wellbore planning manager have been primarily described with reference to wellbore drilling operations; however, the wellbore planning manager described herein may be used in applications other than the drilling of a wellbore. In other embodiments, wellbore planning managers according to the present disclosure may be used outside a wellbore or other downhole environment used for the exploration or production of natural resources. For instance, wellbore planning mangers of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for planning a wellbore, comprising:
receiving an offset protein code sequence for an offset wellbore, wherein the offset protein code sequence includes a plurality of protein codes, each protein code of the plurality of protein codes corresponding to a range of drillability values, wherein the range of drillability values are representative of a formation strength;
preparing a planned wellbore protein code sequence for a planned wellbore based on the offset protein code sequence of the offset wellbore; and
providing an analysis of target surface drilling parameters for the planned wellbore based on the offset protein code sequence.

2. The method of claim 1, wherein providing the analysis of the target surface drilling parameters include providing a heat map of the target surface drilling parameters.

3. The method of claim 1, wherein providing the analysis of the target surface drilling parameters includes providing an analysis of the target surface drilling parameters for a protein code of the planned wellbore protein code sequence.

4. The method of claim 3, wherein providing the analysis of the target surface drilling parameters includes providing the analysis of the target surface drilling parameters for each protein code of the planned wellbore protein code sequence.

5. The method of claim 1, wherein preparing the planned wellbore protein code sequence includes preparing the planned wellbore protein code sequence from a plurality of offset wellbores.

6. The method of claim 5, wherein the plurality of offset wellbores are located within an analysis zone of the planned wellbore.

7. A method for planning a wellbore, comprising:
receiving surface drilling parameters for the wellbore, wherein the surface drilling parameters include at least one of weight-on-bit (WOB), rotations per minute (RPM), drilling fluid flow rate, or rate of penetration (ROP);
inferring downhole drilling parameters based on the surface drilling parameters;
determining a plurality of drillability values for the wellbore based on the inferred downhole drilling parameters, wherein the plurality of drillability values are a proxy for formation strength;
assigning a plurality of protein codes to the plurality of drillability values, wherein each protein code of the plurality of protein codes corresponds to a drillability range of the plurality of drillability values, and wherein each protein code of the plurality of protein code has a depth range corresponding to a depth of the drillability range; and
preparing a protein code sequence for the wellbore based on the plurality of protein codes.

8. The method of claim 7, wherein assigning the plurality of protein codes includes applying a low-pass filter to the plurality of drillability values.

9. The method of claim 7, wherein assigning the plurality of protein codes include identifying a consensus sequence of the plurality of drillability values.

10. The method of claim 9, wherein identifying the consensus sequence includes determining a probability of a mutation within the plurality of drillability values.

11. The method of claim 10, wherein, if the probability of the mutation is above a mutation threshold, identifying the consensus sequence includes omitting the mutation from the plurality of drillability values.

12. The method of claim 9, wherein identifying the consensus sequence includes detecting changepoints in the drillability values.

13. The method of claim 12, wherein assigning the plurality of protein codes includes assigning different protein codes based on the detected changepoints.

14. A method for planning a wellbore, comprising:
receiving a machine learning model trained to identify surface drilling parameters associated with drillability values and a rate of penetration;
providing the machine learning model with offset surface drilling parameters, offset drillability values, and offset rates of penetration for offset wellbores;
using the machine learning model, identifying target surface drilling parameters for a planned wellbore based on the offset surface drilling parameters, the offset drillability values, and the offset rates of penetration for the offset wellbores; and
refining the machine learning model based on observed surface drilling parameters, determined drillability values, and measured rates of penetration for the planned wellbore.

15. The method of claim 14, wherein refining the machine learning model includes refining the machine learning model while the planned wellbore is being drilled.

16. The method of claim 15, further comprising, using the refined machine learning model, modifying the target surface drilling parameters for the planned wellbore.

17. The method of claim 14, wherein identifying the target surface drilling parameters includes preparing a heat map of the target surface drilling parameters.

18. The method of claim 14, wherein providing the machine learning model with the offset drillability values includes providing the machine learning model with an offset protein code sequence, and wherein identifying target surface drilling parameters includes identifying a mutation probability for one or more target protein codes from a target protein code sequence for the planned wellbore.

19. The method of claim 14, further comprising receiving an input for a location of the target surface drilling parameters, and wherein identifying the target surface drilling parameters includes identifying the target surface drilling parameters for the location.

20. The method of claim 19, wherein providing the machine learning model with offset surface drilling parameters includes providing the machine learning model with offset surface drilling parameters, drillability values, and offset rates of penetration from an offset zone surrounding the planned wellbore.
